(19) United States
(12) Patent Application Publication
(10) Pub. No.: US 2026/0302412 A1
(43) Pub. Date: Oct. 1, 2026

(54) SECONDARY BATTERY AND METHOD FOR MANUFACTURING SECONDARY BATTERY

(71) Applicant: TOYOTA JIDOSHA KABUSHIKI KAISHA, Toyota-shi (JP)

(72) Inventor: Kazuki TAGA, Obu-shi (JP)

(73) Assignee: TOYOTA JIDOSHA KABUSHIKI KAISHA, Toyota-shi (JP)

(21) Appl. No.: 19/418,241

(22) Filed: Dec. 12, 2025

(30) Foreign Application Priority Data
Feb. 5, 2025 (JP) 2025-017681

(51) Int. Cl. H01M 10/654; H01M 10/04; H01M 10/653; H01M 50/103

(52) U.S. Cl. CPC H01M 10/654; H01M 10/049; H01M 10/653; H01M 50/103; H01M 2300/0065

(57) ABSTRACT

The present disclosure relates to a secondary battery. The secondary battery includes: an electrode assembly; an outer casing that houses the electrode assembly; and a filler that fills a gap between the electrode assembly and the outer casing. The outer casing has an uneven structure provided at a portion in contact with the filler.

### CROSS-REFERENCE TO RELATED APPLICATION

This application claims priority to Japanese Patent Application No. 2025-017681 filed on Feb. 5, 2025. The disclosure of the above-identified application, including the specification, drawings, and claims, is incorporated by reference herein in its entirety.

### BACKGROUND

### 1. Technical Field

The present disclosure relates to a secondary battery and a method for manufacturing the secondary battery.

### 2. Description of Related Art

Secondary batteries that can be used repeatedly by charging are known. In general secondary batteries, a structure including electrodes and other members (hereinafter also referred to as “electrode assembly”) is housed inside an outer casing. Therefore, it is important to dissipate heat generated by chemical reaction in the electrode assembly to the outside of the outer casing from the viewpoint of, for example, suppressing deterioration of the secondary battery and preventing damage.

For example, Japanese Unexamined Patent Application Publication No. 2020-13702 (JP 2020-13702 A) describes an all-solid-state battery cell in which a heat transfer member in contact with an electrode assembly and an outer casing is disposed inside the outer casing to improve cooling efficiency.

### SUMMARY

In recent years, measures against heat generation have become increasingly important as the capacity and voltage of secondary batteries have increased.

In view of the above circumstances, an object of the present disclosure is to provide a secondary battery with excellent cooling efficiency and a method for manufacturing the secondary battery.

Means for achieving the above object include the following aspects.
<1> A secondary battery including:
   an electrode assembly;
   an outer casing that houses the electrode assembly; and
   a filler that fills a gap between the electrode assembly and the outer casing, in which the outer casing has an uneven structure provided at a portion in contact with the filler.
<2> The secondary battery according to <1>, in which the uneven structure is provided linearly along a longitudinal direction of the outer casing.
<3> The secondary battery according to <1> or <2>, in which the uneven structure is provided at a portion of the outer casing that faces a side surface of the electrode assembly.
<4> The secondary battery according to any one of <1> to <3>, in which the secondary battery is a solid-state battery.
<5> A method for manufacturing the secondary battery according to any one of <1> to <4>, the method including:
   housing the electrode assembly in the outer casing; and
   filling the gap between the electrode assembly and the outer casing with the filler.

The present disclosure provides the secondary battery with excellent cooling efficiency and the method for manufacturing the secondary battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing an example of the configuration of a secondary battery of the present disclosure; and

FIG. 2 is a sectional view schematically showing the example of the configuration of the secondary battery of the present disclosure.

### DETAILED DESCRIPTION OF EMBODIMENTS

Hereinafter, an exemplary embodiment of the present disclosure will be described. The following descriptions and examples are intended to illustrate the embodiment and are not intended to limit the scope of the present disclosure.

In the present disclosure, a numerical range expressed using “to” refers to a range inclusive of the values before and after “to” as the lower limit and the upper limit, respectively.

In numerical ranges described in stages in the present disclosure, the upper or lower limit of one numerical range may be replaced with the upper or lower limit of another numerical range described in stages. In numerical ranges described in the present disclosure, the upper or lower limit of a numerical range may be replaced with a value described in the examples.

In the present disclosure, when a plurality of substances corresponding to each component is present in a composition, the amount of each component in the composition refers to the total amount of the substances present in the composition unless otherwise specified.

In the present disclosure, a combination of two or more preferred forms is considered to be a more preferred form.

In the present disclosure, the term “step” includes not only independent steps but also steps that are not clearly distinguishable from other steps, as long as the intended purpose of the step is achieved.

In the present disclosure, a “solid-state battery” refers to a secondary battery that uses at least a solid electrolyte as an electrolyte. Thus, the solid-state battery of the present disclosure includes batteries named differently, such as all-solid-state batteries and semi-solid-state batteries.

### Secondary Battery

One embodiment of the present disclosure is a secondary battery including:
an electrode assembly;
an outer casing that houses the electrode assembly; and
a filler that fills a gap between the electrode assembly and the outer casing, in which the outer casing has an uneven structure provided on a surface in contact with the filler.

In the secondary battery of the present disclosure, the gap between the electrode assembly and the outer casing is filled with the filler. Therefore, heat generated in the electrode assembly is transferred more efficiently to the outer casing via the filler than in the case where the gap between the electrode assembly and the outer casing is not filled with the filler.

In the secondary battery of the present disclosure, the outer casing has the uneven structure provided at the portion in contact with the filler. Therefore, the contact area between the outer casing and the filler is larger than in the case where the portion of the outer casing in contact with the filler is flat (i.e., no uneven structure is provided). As a result, heat generated in the electrode assembly is transferred more efficiently to the outer casing via the filler.

The volume of the electrode assembly housed in the outer casing changes as the secondary battery is charged and discharged. Therefore, the thickness, material, and other conditions of the outer casing are restricted to a range that can withstand a stress generated in the outer casing due to the change in volume of the electrode assembly. The uneven structure provided at the portion of the outer casing in contact with the filler serves to disperse the stress generated in the outer casing (particularly in the corner). As a result, for example, the thickness required in the outer casing can be reduced, and the volume ratio of the electrode assembly in the secondary battery can be increased.

In the present disclosure, the uneven structure provided on the surface of the outer casing in contact with the filler may include protrusions formed on the surface of the outer casing, include recesses formed on the surface of the outer casing, or include both protrusions and recesses formed on the surface of the outer casing.

In the present disclosure, the “protrusion” refers to a portion that is raised from a surface of the outer casing that does not have the uneven structure (hereinafter also referred to as “reference surface of outer casing”).

In the present disclosure, the “recess” refers to a portion that recedes from the reference surface of the outer casing.

The height difference of the uneven structure provided on the surface of the outer casing in contact with the filler is not particularly limited, and can be set depending on the shape, size, etc. of the secondary battery.

When the uneven structure is formed by protrusions, the height difference of the uneven structure refers to the height of each protrusion (distance from the top of the protrusion to the reference surface of the outer casing).

When the uneven structure is formed by recesses, the height difference of the uneven structure refers to the depth of each recess (distance from the bottom of the recess to the reference surface of the outer casing).

When the uneven structure is formed by protrusions and recesses, the height difference of the uneven structure refers to the sum of the height of each protrusion and the depth of each recess.

From the viewpoint of improving the cooling efficiency of the secondary battery, the height difference of the uneven structure provided on the surface of the outer casing in contact with the filler is preferably greater than the surface roughness Ra (JIS B 0601:2013) of the reference surface of the outer casing. For example, the height difference of the uneven structure can be selected from a range of 10μm to 1000μm. From the viewpoint of improving the cooling efficiency of the secondary battery, the height difference of the uneven structure is preferably 100 μm or more.

There are no particular limitations on the shape of the protrusion or recess that forms the uneven structure when the portion of the outer casing having the uneven structure is observed in a normal direction. For example, the shape of the protrusion or recess may be a linear shape or a dot shape.

The uneven structure is preferably provided linearly along a longitudinal direction of the outer casing.

In the present disclosure, the longitudinal direction of the outer casing refers to a direction along the long side of a rectangular prism when the outer casing has a substantially rectangular prism shape, and refers to a direction along the long axis of a cylinder when the outer casing has a substantially cylindrical shape.

When the uneven structure is provided linearly along the longitudinal direction of the outer casing, it is easier to ensure a sufficient contact area between the outer casing and the filler, and heat generated in the electrode assembly tends to be transferred efficiently to the outer casing via the filler.

When a fluidic filler is supplied and flows inside the outer casing that houses the electrode assembly, the linear uneven structure functions as a channel, and the efficiency tends to be improved in terms of the process of filling the outer casing with the filler.

The uneven structure is preferably provided at a portion of the outer casing that faces a side surface of the electrode assembly.

In the present disclosure, the side surface of the electrode assembly refers to a portion observed in a direction perpendicular to the thickness direction of the electrode assembly.

When the electrode assembly is a laminate of a plurality of electrodes, the lamination direction of the electrodes corresponds to the thickness direction of the electrode assembly.

The electrode assembly expands in volume when the secondary battery is charged. The degree of volume expansion in a direction perpendicular to the thickness direction of the electrode assembly is smaller than the degree of volume expansion in the thickness direction of the electrode assembly. For this reason, the uneven structure provided at the portion of the outer casing that faces the side surface of the electrode assembly is less susceptible to the effects of volume expansion of the electrode assembly. As a result, peeling is less likely to occur at the interface between the uneven structure and the outer casing or the filler, and good cooling efficiency is maintained for the secondary battery.

When the uneven structure is provided at the portion of the outer casing that faces the side surface of the electrode assembly, the cooling efficiency of the secondary battery can be improved without increasing the thickness of the outer casing relative to the thickness of the electrode assembly.

The uneven structure is preferably such that the protrusions of the uneven structure are formed or the recesses of the uneven structure are not formed at the corners of the space that houses the electrode assembly.

When the uneven structure is in the above state, it is possible to effectively suppress a decrease in strength at the corners of the space that houses the electrode assembly. As a result, the cooling efficiency of the secondary battery can be improved without increasing the thickness of the outer casing to ensure strength.

There are no particular limitations on the shape of the uneven structure when a cross section of the portion of the outer casing having the uneven structure is observed. For example, the shape of the protrusion or recess that forms the uneven structure may be a rectangle, a triangle, or a semicircle. The shape of the protrusion or recess may be regular or irregular.

From the viewpoint of improving the cooling efficiency of the secondary battery, the portion of the outer casing in contact with the filler preferably has a high increase rate of the contact area with the filler due to the uneven structure, which is calculated by the following expression.

Specifically, the increase rate of the contact area with the filler that is represented by the following expression may be 105% or more, 110% or more, or 120% or more. The upper limit of the increase rate of the contact area with the filler that is represented by the following expression is not particularly limited, and may be 300% or less, 250% or less, or 200% or less from the viewpoint of allowing the filler to enter the uneven structure.

$$Increase rate of contact area with filler ( \% ) = ( X 1 / X 2 ) \times 100$$

In the expression, X1 is the actual surface area of the portion of the outer casing provided with the uneven structure, and X2 is the two-dimensional area of the portion of the outer casing provided with the uneven structure (i.e., the surface area when the portion is assumed to be completely flat).

There are no particular limitations on the method for forming the uneven structure at the portion of the outer casing in contact with the filler, and the method can be selected depending on the material of the outer casing, the shape of the protrusion or recess that forms the uneven structure, etc.

Specific examples of the method for forming the uneven structure at the portion of the outer casing in contact with the filler include embossing, cutting, corrugating, etching, and injection molding.

The secondary battery of the present disclosure is preferably a solid-state battery. In a secondary battery that uses a liquid electrolyte (hereinafter also referred to as “electrolyte solution”), the inside of the outer casing is filled with the electrolyte solution. In the solid-state battery, the inside of the outer casing is not filled with an electrolyte solution. Therefore, a gap is likely to be present between the electrode assembly and the outer casing. For this reason, when the secondary battery of the present disclosure is the solid-state battery, the effect of improving the cooling efficiency is more remarkable.

An example of the configuration of the secondary battery of the present disclosure will be described with reference to the drawings. In each drawing, members (terminals etc.) other than the electrode assembly, the outer casing, and the filler that constitute the secondary battery are omitted. The dimensions, shapes, etc. of the members shown in each drawing are merely conceptual examples, and the dimensions, shapes, etc. of the actual secondary battery and members are not limited to these.

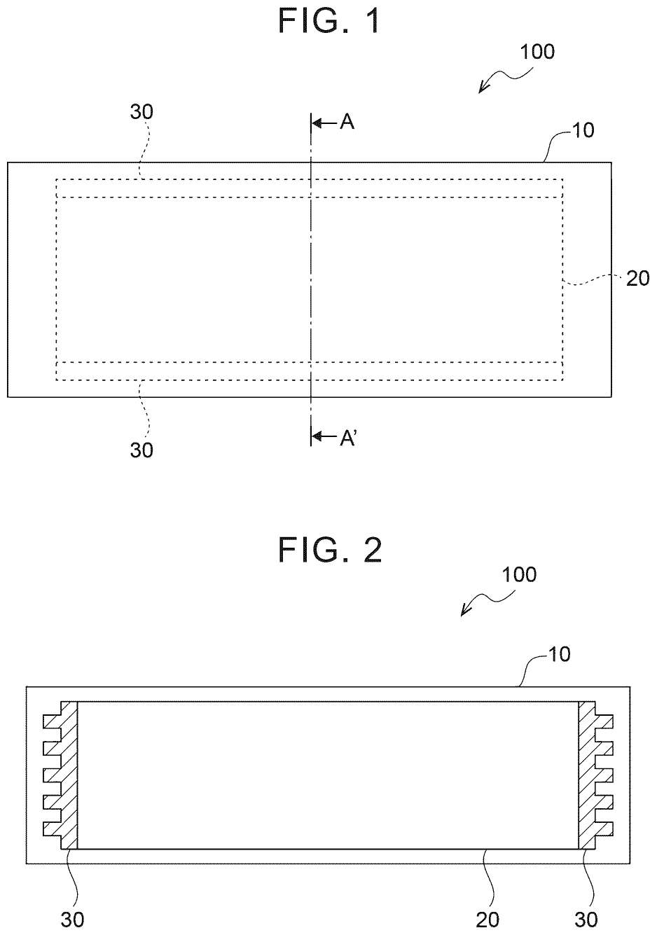

FIG. 1 is a plan view schematically showing the example of the configuration of the secondary battery of the present disclosure. More specifically, FIG. 1 is a plan view of a principal surface side of the secondary battery having a substantially rectangular prism shape.

FIG. 2 is a sectional view schematically showing the example of the configuration of the secondary battery of the present disclosure. More specifically, FIG. 2 is a sectional view of the secondary battery shown in FIG. 1 taken along line A-A′ (i.e., in a direction perpendicular to the longitudinal direction of the secondary battery).

As shown in FIGS. 1 and 2, a secondary battery 100 includes an electrode assembly 20 and an outer casing 10 that houses the electrode assembly 20. A gap between the electrode assembly 20 and the outer casing 10 is filled with a filler 30. The filler 30 is provided along a longitudinal direction of the secondary battery 100 at a portion of the outer casing 10 that faces the side surface of the electrode assembly 20.

The outer casing 10 has an uneven structure provided at a portion in contact with the filler 30. The uneven structure is provided at a portion of the outer casing 10 that faces the side surface of the electrode assembly 20.

The secondary battery 100, the outer casing 10, and the electrode assembly 20 shown in FIGS. 1 and 2 each have a substantially rectangular prism shape, but the present disclosure is not limited to this configuration. For example, the secondary battery 100, the outer casing 10, and the electrode assembly 20 may each have a cylindrical shape.

In the secondary battery of the present disclosure, the gap between the electrode assembly and the outer casing inside the outer casing may be entirely filled with the filler, or may be partially filled with the filler.

From the viewpoint of improving the cooling efficiency of the secondary battery, in the gap between the electrode assembly and the outer casing, at least a gap located between the outer casing and the side surface of the electrode assembly is preferably filled with the filler.

When the gap between the side surface of the electrode assembly and the outer casing is filled with the filler, the other gaps (e.g., a gap between the electrode in the outermost layer of the laminate of the electrode assembly and the outer casing) may or may not be filled with the filler.

The filler that fills the gap between the electrode assembly and the outer casing may be one kind or a combination of two or more kinds.

Hereinafter, the members constituting the secondary battery of the present disclosure will be described. In the following description, an anode current collector and a cathode current collector may be referred to as “current collector” without distinction, an anode layer and a cathode layer may be referred to as “electrode” without distinction, and an anode active material and a cathode active material may be referred to as “electrode active material” without distinction.

In the secondary battery of the present disclosure, the material of the outer casing is not particularly limited, and can be selected depending on the application of the secondary battery, etc. From the viewpoint of durability, ease of processing, etc. of the secondary battery, metal and resin are preferable as the material of the outer casing. The outer casing may be made of one kind of material or two or more kinds of material. For example, the outer casing may be made of metal and resin in combination.

In the secondary battery of the present disclosure, the kind of the filler that fills the inside of the outer casing is not particularly limited, and can be selected depending on the application of the secondary battery, etc.

From the viewpoint of improving the cooling efficiency of the secondary battery, the filler is preferably a substance having a higher thermal conductivity than air. The filler may be a solid, gas, or liquid, or a combination of them.

From the viewpoint of adhesion between the filler and the outer casing and weight reduction of the secondary battery, the filler preferably contains resin. As the resin, a thermoplastic resin, a thermosetting resin, an elastomer, etc. can be used without any particular limitation.

When the filler contains resin, the filler may further contain an inorganic filler. The filler containing the inorganic filler is effective from the viewpoint of, for example, improving the thermal conductivity of the filler, adjusting the thermal expansion coefficient, and improving the mechanical strength. Specific examples of the material of the inorganic filler include alumina, silica, zirconia, carbon, and glass.

In the secondary battery of the present disclosure, the electrode assembly may include a structure in which an anode current collector, an anode layer, an intermediate layer, a cathode layer, and a cathode current collector are disposed in this order. The electrode assembly may include a plurality of the structures described above.

The kind of the current collector in the electrode assembly is not particularly limited, and can be selected from known current collectors. Specific examples of the material of the current collector include metals selected from among Ag, Cu, Au, Al, Ni, Fe, and Ti, and alloys containing these metals. In an embodiment of the present disclosure, the cathode current collector may contain Al and the anode current collector may contain Cu.

The thickness of the current collector is not particularly limited, and can be selected in consideration of the type, scale, etc. of the battery obtained using the current collector. The thickness of the current collector may be, for example, 5 μm or more, 10 μm or more, or 20 μm or more. The thickness of the current collector may be, for example, 120 μm or less, 80 μm or less, or 60 μm or less.

### Electrode Layer

The electrode layer in the electrode assembly contains at least an electrode active material, and may contain a binder, a conductive material, a solid electrolyte, etc. as necessary.

Specific examples of the anode active material include carbon materials, active materials containing silicon (Si), metallic lithium, lithium-containing alloys, metals or alloys that can be alloyed with lithium, oxides, and transition metal nitrides.

Examples of carbon materials include graphite materials, amorphous carbon materials, carbon black, and activated carbon. Examples of graphite materials include natural graphite and artificial graphite. Examples of amorphous carbon materials include hard carbon, soft carbon, coke, mesocarbon microbeads (MCMBs), and mesophase pitch-based carbon fibers (MCFs). The graphite material may be coated with metal or amorphous carbon.

Examples of active materials containing Si include pure silicon, silicon alloys (e.g., alloys of Si and one or more metals selected from the group consisting of Sn, Ti, Fe, Ni, Cu, Co, and Al), porous silicon, silicon clathrate compounds, and silicon oxides.

Specific examples of the cathode active material include composite oxides containing lithium and a transition metal (hereinafter also referred to as “composite oxides”). Examples of composite oxides include composite oxides having a layered crystal structure, composite oxides having a spinel crystal structure, and composite oxides having an olivine crystal structure. Specific examples of composite oxides having a layered crystal structure include a compound represented by LiMO₂ (where M is at least one transition metal selected from the group consisting of Ni, Co, and Mn) and a compound obtained by adding a dissimilar element to this compound. Representative examples of composite oxides having a layered crystal structure include a lithium cobalt oxide (LCO), a lithium nickel cobalt manganese oxide (NCM), and a lithium nickel oxide or a lithium nickel cobalt aluminum oxide (NCA). Specific examples of composite oxides having a spinel crystal structure include LiMn₂O₄. Specific examples of composite oxides having an olivine crystal structure include LiMPO₄ (where M is Fe, Co, Ni, or Mn).

The electrode active material contained in the electrode layer may be one kind or a combination of two or more kinds.

The electrode active material may be in the form of, for example, fibers, spheres, or flakes.

The volume average particle size of the electrode active material may be selected, for example, from a range of 5 μm to 50 μm. The volume average particle size of the electrode active material is defined as a value (D50) at which the cumulation from the small diameter side reaches 50% in a volume-based particle size distribution obtained by a laser diffraction and scattering method.

Specific examples of the binder include polyvinylidene fluoride (PVdF), polyethylene, polypropylene, polyethylene terephthalate, cellulose, nitrocellulose, carboxymethyl cellulose, polyethylene oxide, polyepichlorohydrin, polyacrylonitrile, styrene-butadiene rubber (SBR), acrylonitrile-butadiene rubber (NBR), polyacrylate, polymethacrylate, and polytetrafluoroethylene (PTFE).

The binder contained in the electrode layer may be one kind or a combination of two or more kinds.

Examples of the conductive material include a carbon material, a metal, an oxide that exhibits conductivity, and a nitride that exhibits conductivity.

Specific examples of the carbon material include graphite, carbon black (acetylene black, thermal black, furnace black, etc.), a carbon nanotube (CNT), a carbon nanofiber (CNF), and a vapor grown carbon fiber (VGCF, trademark).

The conductive material contained in the electrode layer may be one kind or a combination of two or more kinds.

The thickness of the electrode layer is not particularly limited, and can be selected, for example, from a range of 1 μm to 100 μm.

Examples of the solid electrolyte contained in the electrode layer include a sulfide solid electrolyte, an oxide solid electrolyte, and a polymer solid electrolyte.

From the viewpoint of battery performance, the solid electrolyte is preferably the sulfide solid electrolyte or the polymer solid electrolyte. From the viewpoint of thermal stability, the sulfide solid electrolyte is more preferable.

The solid electrolyte contained in the electrode layer may be one kind or a combination of two or more kinds.

The sulfide solid electrolyte may be a compound containing a metal element serving as conduction ions and sulfur (S).

Examples of the metal element include Li, Na, K, Mg, and Ca. Among these, Li is preferable as the metal element.

The sulfide solid electrolyte may contain Li, S, and at least one kind selected from the group consisting of P, Si, Ge, Al, and B. Among these, a sulfide solid electrolyte containing Li, S, and P (hereinafter also referred to as “LPS sulfide solid electrolyte”) is preferable.

From the viewpoint of ion conductivity, the sulfide solid electrolyte may contain a halogen element such as Cl, Br, or I. From the viewpoint of chemical stability, the sulfide solid electrolyte may contain oxygen (O).

Specific examples of the LPS sulfide solid electrolyte include Li₂S—P₂S₅, Li₂S—P₂S₅—LiI, Li₂S—-P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, LiI—Li₂S—P₂O₅, LiI—Li₃PO₄—P₂S₅, LiBr—LiI—Li₂S—P₂S₅, Li₂S—P₂S₅—ZₘSₙ (where m and n are positive numerals, and Z is Ge, Zn, or Ga), Li₂S—GeS₂, Li₂S—SiS₂—Li₃PO₄, and Li₂S—SiS₂—LiₓMO_{y} (where x and y are positive numerals, and M is P, Si, Ge, B, Al, Ga, or In).

In the above, the notation “Li₂S—P₂S₅” refers to a sulfide solid electrolyte obtained using Li₂S and P₂S₅ as raw materials, and the same applies to the other notations.

Among the LPS sulfide solid electrolytes, a sulfide solid electrolyte obtained using Li₂S and P₂S₅ is preferable, and a sulfide solid electrolyte that satisfies the following formula is more preferable.

$${Li}_{3 + x + 5 y} {P}_{1 - y} {S}_{4} ( 0 < x \leq 0.6 , 0 < y \leq 0.2 )$$

The oxide solid electrolyte may be a compound having a NASICON (Na₃Zr₂PSi₂O₁₂) crystal structure. The compound having the NASICON crystal structure has high ion conductivity and is highly stable in the air.

Examples of the compound having the NASICON crystal structure include a phosphate containing lithium. Examples of the phosphate include a composite lithium phosphate with Ti (e.g., Li₁₊ₓAlₓTi₂₋ₓ(PO₄)₃), and a compound in which all or part of Ti in the composite lithium phosphate is replaced with a tetravalent transition metal such as Ge, Sn, Hf, or Zr, or with a trivalent transition metal such as Al, Ga, In, Y, or La.

Specific examples of the compound having the NASICON crystal structure include a Li—Al—Ge—P—O based material (Li₁₊ₓAlₓGe₂₋ₓ(PO₄)₃), a Li—Al—Zr—P—O based material (Li₁₊ₓAlₓZr₂₋ₓ(PO₄)₃), and a Li—Al—Ti—P—O based material (Li₁₊ₓAlₓTi₂₋ₓ(PO₄)₃).

The polymer solid electrolyte may be a mixture (complex) of a polymer compound and an electrolyte salt. Specific examples of the polymer compound include polyether-based polymer compounds such as polyethylene oxide (PEO) and polypropylene oxide (PPO), polyamine-based polymer compounds such as polyethyleneimine (PEI), and polysulfide-based polymer compounds such as polyalkylene sulfide (PAS). Among these, the polyether-based polymer compounds are preferable.

### Intermediate Layer

Examples of the intermediate layer contained in the electrode assembly include a separator to be used in a battery that uses an electrolyte solution, and an electrolyte layer to be used in an all-solid-state battery.

In the present disclosure, the “electrolyte layer” refers to a layer containing a solid electrolyte.

The thickness of the intermediate layer is not particularly limited, and can be selected, for example, from a range of 1 μm to 100 μm.

When the intermediate layer is a separator, the kind of the separator is not particularly limited, and the separator can be selected from among known separators.

Specific examples of the separator include porous sheets made of resins such as polyethylene, polypropylene, polymethylpentene, polyester, cellulose, and polyamide.

When the intermediate layer is an electrolyte layer, the kind of the solid electrolyte contained in the electrolyte layer is not particularly limited. For example, the solid electrolyte may be selected from the solid electrolytes that may be contained in the electrode layer described above.

When the intermediate layer is an electrolyte layer, the anode layer or the cathode layer may contain a solid electrolyte. In this case, the kinds of the solid electrolytes contained in the layers may be the same or different.

When the secondary battery of the present disclosure includes an electrolyte solution as an electrolyte, the kind of the electrolyte solution is not particularly limited, and any known electrolyte solution may be used. Specific examples of the electrolyte solution include liquids obtained by dissolving a lithium salt such as LiPF₆ or LiFSi in an organic solvent.

### Applications of Secondary Battery

The applications of the secondary battery of the present disclosure are not particularly limited. Typical applications include power supplies for vehicles, electronic devices, and power storage systems. Among these, the secondary battery of the present disclosure is preferably used as a power supply for vehicles, and also preferably used as a power supply for driving a hybrid electric vehicle, a plug-in hybrid electric vehicle, or a battery electric vehicle.

Examples of such vehicles include electric four-wheel vehicles, electric two-wheel vehicles, gasoline vehicles, and diesel vehicles. Examples of electric four-wheel vehicles include battery electric vehicles (BEVs), plug-in hybrid electric vehicles (PHEVs), and hybrid electric vehicles (HEVs). Examples of electric two-wheel vehicles include electric motorcycles and electric assist bicycles.

### Method for Manufacturing Secondary Battery

One embodiment of the present disclosure is a method for manufacturing the secondary battery of the present disclosure, the method including:
housing the electrode assembly in the outer casing; and
filling the gap between the electrode assembly and the outer casing with the filler.

With the method of the present disclosure, a secondary battery with excellent cooling efficiency can be manufactured.

In the method of the present disclosure, the methods for carrying out the step of housing the electrode assembly in the outer casing and the step of filling the gap between the electrode assembly and the outer casing with the filler are not particularly limited, and may be known methods.

The step of filling the gap between the electrode assembly and the outer casing with the filler may include supplying a fluidic filler into the outer casing that houses the electrode assembly. The filler supplied into the outer casing may be caused to flow inside the outer casing by utilizing pressure, gravity, etc. In this case, the uneven structure provided to the outer casing may function as a channel for the filler to flow.

The method may include steps other than the above steps as necessary. For example, the method of the present disclosure may include a step of curing the filler after the step of filling the gap between the electrode assembly and the outer casing with the filler.

What is claimed is:

1. A secondary battery comprising:
an electrode assembly;
an outer casing that houses the electrode assembly; and
a filler that fills a gap between the electrode assembly and the outer casing, wherein the outer casing has an uneven structure provided at a portion in contact with the filler.

2. The secondary battery according to claim 1, wherein the uneven structure is provided linearly along a longitudinal direction of the outer casing.

3. The secondary battery according to claim 1, wherein the uneven structure is provided at a portion of the outer casing that faces a side surface of the electrode assembly.

4. The secondary battery according to claim 1, wherein the secondary battery is a solid-state battery.

5. A method for manufacturing the secondary battery according to claim 1, the method comprising:
housing the electrode assembly in the outer casing; and
filling the gap between the electrode assembly and the outer casing with the filler.
